(19) United States
(12) Patent Application Publication
(10) Pub. No.: US 2016/0002867 A1
(43) Pub. Date: Jan. 7, 2016

(54) SEALED AGGLOMERATED BASE COMPOSITION FOR A SUB-BASE LAYER COMPRISING A HIGH PROPORTION OF LARGER AGGREGATES

(71) Applicant: COLAS, Boulogne-Billancourt (FR)

(72) Inventor: Philippe HAUZA, Mezieres en Drouais (FR)

(21) Appl. No.: 14/788,870

(22) Filed: Jul. 1, 2015

(30) Foreign Application Priority Data
Jul. 3, 2014 (FR) 14 56401

(51) Int. Cl. E01C 7/18; E01C 3/00; E01C 7/35; C08L 95/00

(52) U.S. Cl. CPC E01C 7/18; C08L 95/00; E01C 3/003; E01C 7/358

(57) ABSTRACT

A sealed agglomerated base (SAB) composition includes at least a hydrocarbon binder and a granular mixture, the granular mixture having the following particle size distribution, by weight, as compared to the granular mixture total weight: 45 to 90% of the granular mixture have a size that is higher than or equal to 10 mm, with at least 25% having a size that is higher than or equal to 20 mm, characterized in that the void content in volume as compared to the SAB composition total volume, as measured according to the NF EN 12697 Standard at 120 gyrations in a gyratory shear compactor (GSC), is lower than or equal to 10%, preferably ranges from 2 to 9% and most preferably from 4 to 8%. A road coating including the SAB composition is also described.

### TECHNICAL FIELD OF THE INVENTION

The present invention relates to the road coating field.

The present invention especially relates to a sealed agglomerated base (SAB) composition comprising at least a hydrocarbon binder and a granular mixture based on aggregates, said granular mixture having a high proportion of strongly grained elements, that is to say with a size higher than 20 mm, or even higher than 31.5 mm.

The present invention also relates to a road coating, which is structurally positioned as a sub-base layer.

### TECHNICAL BACKGROUND

Asphalt mix pavements are made of a superimposition of several layers deposited on the ground to be coated: one capping layer coated with a sub-base layer itself coated with a surfacing layer. The sub-base layer is typically a double layer composed of a road base layer and of a road base course. The surfacing layer likewise may be a double layer composed of a base course and a wearing course or it may be made up of a single layer (wearing course only).

The road base course and road base layers, which form the sub-base layer, must especially ensure the following functions: when building the road, they must provide back to the surfacing layers a supporting substrate, that is homogeneous and well adjusted. They may occasionally act as a temporary wearing course while the road is being built. Lastly, they ensure the thermal protection of the underlying platform and provide to the pavement its mechanical resistance to traffic-induced vertical loads.

The bituminous sub-base layer is generally composed of road base asphalt (RBA) or high modulus asphalt (HMA).

RBA are traditionally composed of a mixture of bitumen and crushed aggregates, which particle size most often is of the continuous type. Currently, the grading standards used are of the 0/10 to 0/14 mm type, less frequently 0/20 mm. Bitumen contents in these products systematically exceed 4% (bitumen weight as compared to the aggregate weight expressed as a percentage) and may reach 5% for the most efficient RBA. Bitumen grades that are usually used are 35/50 or 20/30.

In road base layers or road base courses, RBA are deposited in thickness ranges of from 6 to 15 cm. As a rule, structures of pavements built with road base asphalts in sub-base layers have a total thickness ranging from 8 to 30 cm depending on the traffic level for which the pavement is to be graded.

HMA comprises a mixture of crushed aggregates of the same particle size as for the RBA (diameter or size limited to 20 mm or more preferably to 14 mm) with a harder bitumen that the one used for RBA (grade 10/20 or 15/25 for HMA2, 20/30 for HMA1). Where required, a grade 35/50 is accepted, but in such a case, the latter has to receive some additives (for example cable waste).

Moreover, the binder content of HMA is higher than in RBA (ranging from 5.2 to 6% by weight as compared to HMA total weight). HMA formulations thus have a high rigidity modulus and a better fatigue and rutting resistance than RBA. HMA thus enable to form a base layer or a road base course with a lower thickness as compared to RBA (of about 6 to 15 cm, depending on traffic projections) while providing a good resistance to fatigue and to rutting, and enabling to minimize additional works (for example pipe path layout, maximum height restrictions for guide rail, roadside structures, etc.).

The evolution of the sub-base layer formulations thus tends to use compositions with increasing bitumen contents (from 4 to 5% by weight as compared to RBA total weights and from 5.2 to 6% by weight as compared to HMA total weight) with harder bitumens (35/50 to 20/30 for RBA and 15/25 to 10/20 for HMA) and sometimes provided with some additives so as to improve the mechanical performances of the formulations. The granular skeleton on the contrary shows a maximum particle size which tends to decrease (from 20 mm to 14 mm, even 10 mm). Current formulations moreover have an increasing rigidity modulus.

Also known from the state of the art is EPO 381 903, which describes a porous asphalt mix (not so compacted) intended to be used for making sub-base layers for pavements. The asphalt mix of this document is said to be “porous” or “open-textured” because of its high void volume of about 20 to 50%.

Such porous asphalt mix comprises in particular a granular mixture composed of larger sized aggregates and of a bituminous hydrocarbon binder which may be doped. Particularly, the granular mixture comprises by weight, as compared to the total weight: 85 to 100% of aggregates with a d/D grading of 6/60 mm, 0 to 10% of sands with a d/D diameter of 0/6 mm, and 0 to 5% of fines, which particle size is lower than 80 μm. Exemplified asphalt mixes comprise by weight 76% or 88% of aggregates with size 20/40 mm for a void volume of respectively 35% and 20%.

Many benefits of such porous mix asphalts are mentioned in this document (absorption of a substantial part of ambient noise, increase in the tire adherence of vehicles). However none of these benefits have been supported by practical technical trials. No mechanical variable, such as fatigue resistance, rigidity modulus, has been determined for example. Moreover, this teaching dated back to 1989 has never been normalized in the state of the road technology in France.

WO 2013/093046 describes a composition of a self-placing, open-textured or porous (less compacted) asphalt mix comprising mineral solid fractions coated with a bituminous binder, that has been modified by adding polymers and adhesion agents and comprising mineral fibers and/or synthetic fibers. The void percentage (water and air pockets within the open-textured asphalt mix), after the asphalt mix has been implemented and cooled, does range from 15 to 50%, advantageously from 25 to 50% and more advantageously from 25 to 40%.

The mineral solid fractions more particularly comprise fines (particle size ≦0.063 mm), crushed and/or semi-crushed sand (particle size ranging from 0.0063 to 2 mm or from 0.0063 to 4 mm), chips (particle size ranging from 14 to 50 mm), and reclaimed asphalt pavements (RAP).

In the experiment section, the exemplified asphalt mixes comprise by weight: 80% or 83% of aggregates with a size 20/40 mm and 11.5% of sands 0/4 mm for 3.4% of bitumen.

Likewise, as regards this teaching, neither the fatigue resistance nor the rigidity modulus has been measured.

Although the sub-base layer formulations according to the prior art are satisfactory, there is still a need for new formulations with good mechanical performances, in particular in terms of fatigue. There is especially a need for sub-base layer formulations which would provide an outstanding durability, a high resistance to static puncturing and a good compactness, while offering a good quality-price ratio.

It is thus an object of the present invention to provide as a new product a particularly compact (not open-textured or not porous) sealed agglomerated base (SAB) composition for a sub-base layer, which would at least partially satisfy the above-mentioned criteria and in particular would be provided with performances at least similar to those of RBA formulations, or structurally similar to those of the previously described HMA.

### AIM OF THE INVENTION

To this end, it is an object of the present invention to provide a SAB composition for a sub-base layer comprising at least a hydrocarbon binder and a granular mixture based on aggregates (such as fines, sands, chips, small gravels, asphalt mix aggregates, ballasts), said granular mixture having the following particle size distribution by weight, as compared to the granular mixture total weight:
45 to 90%, preferably 50 to 70% of said granular mixture have a size that is higher than or equal to 10 mm,
   with at least 25%, preferably at least 30% and most preferably at least 33%, typically 35 to 50%, having a size that is higher than or equal to 20 mm (the rest being aggregates with a particle size of 10/20 mm),
      characterized in that the void content, in volume, as compared to the SAB composition total volume as measured according to the NF EN 12697 Standard at 120 gyrations in a gyratory shear compactor (GSC), is lower than or equal to 10%, preferably is lower than or equal to 8%, even lower than or equal to 6%.

The applicant surprisingly discovered that a high proportion of strongly grained elements with a particle size higher than or equal to 10 mm, even to 20 mm, enables to obtain a sub-base layer with very little porosity and having outstanding mechanical properties, at least similar to those of a RBA class 4, and requiring upon implementation the application of only one layer of the SAB composition of the invention to form said sub-base layer.

In addition, using a high amount of strongly grained elements makes it possible to control the development of the fatigue cracks, which appear over time, rendering the product as robust as, while being more economical than, RBA and HMA used to date.

Moreover, the SAB composition of the invention has an excellent compactness (void content 10%), which enables to compete with HMA in terms of mechanical properties. It ensures in this way an excellent sealing level towards the ground support.

The present invention also relates to a road coating comprising the above-mentioned SAB composition. In particular the thus formed road coating is a sub-base mono-layer having a thickness of from 8 to 20 cm forming both the base layer and the road base course of a traditional sub-base layer. This characteristic in this way makes unnecessary the application of one of the two layers that usually form a sub-base layer, even also to spare a tack coat.

The SAB composition of the invention thus enables, thanks to the characteristics thereof, to ensure an excellent compactness for a very broad range of thicknesses of from 8 to 20 cm and this, in a single layer.

The SAB composition of the invention is thus at variance with the evolution of the formulations for a sub-base layer used to date. Unlike the potential expectations of a person skilled in the art, using a high proportion of aggregates having a size higher than 10 mm and higher than 20 mm provides an excellent suppleness, making it easy to implement, within a thickness range satisfying all the traditional requirements and even beyond that, while offering a good mechanical resistance and in particular an improved puncturing resistance as compared to that of traditional bituminous mixtures.

Other non-limiting and beneficial characteristics of the SAB of the invention, considered either separately or in any technically feasible combination, will be described thereafter.

### DETAILED DESCRIPTION OF AN EMBODIMENT

The contents of the present invention and the way to carry out the same will be better understood upon reading the following description in conjunction with the appended drawings, given as non-limiting illustrative examples.

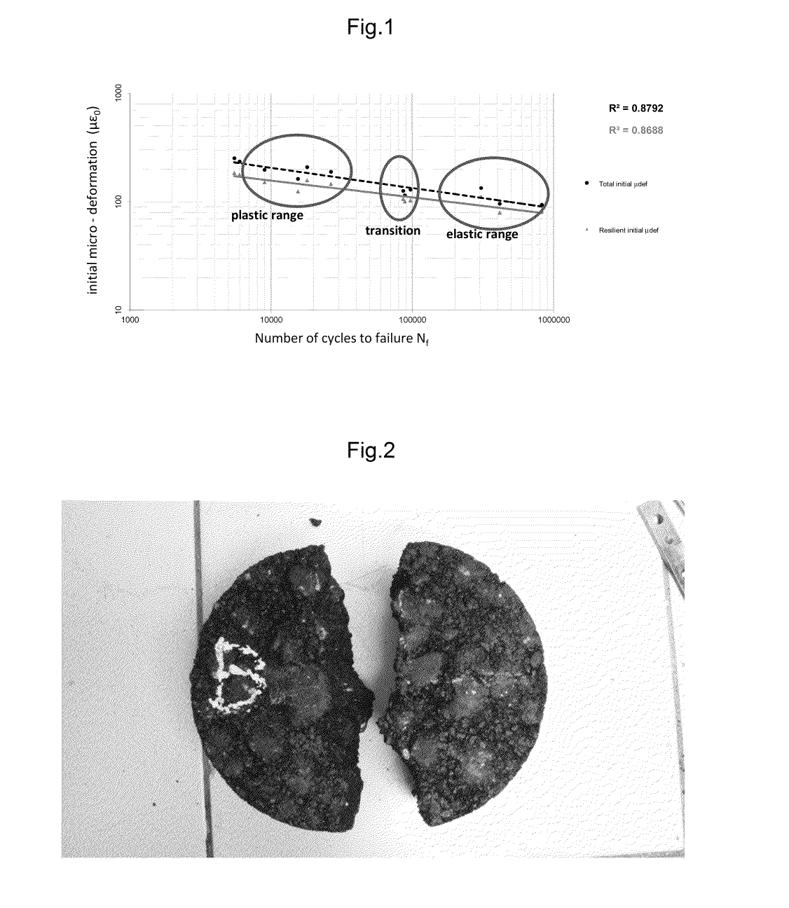

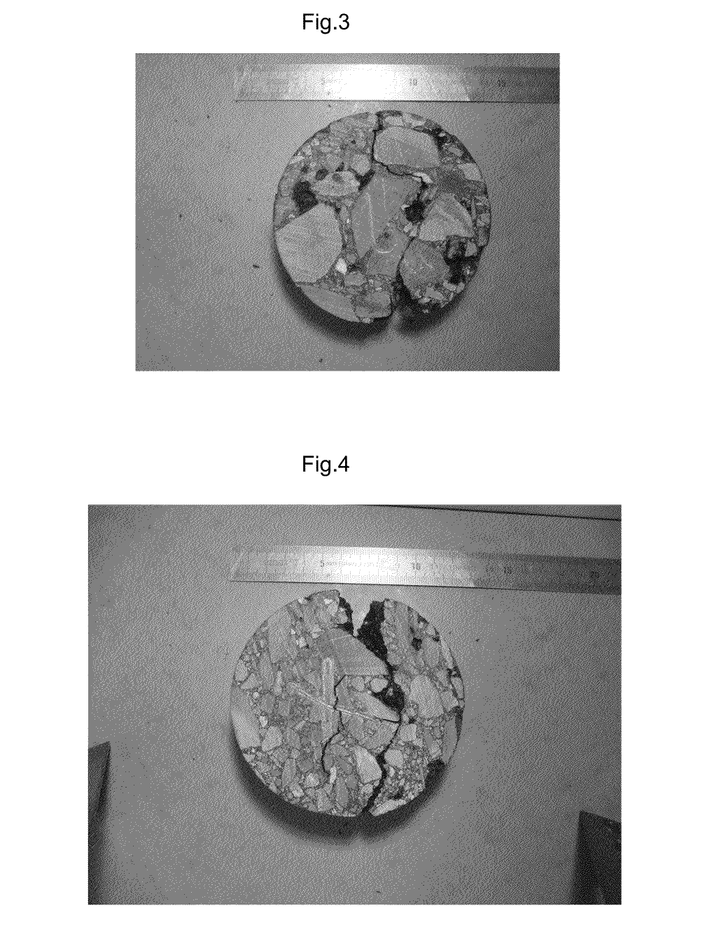

The appended figures show:
on FIG. 1 a diagram showing the fatigue straight line obtained with a SAB composition via the indirect tensile fatigue test, ITFT, (diametral compression fatigue: initial micro-deformation μdef₀ of 12 core specimens on the asphalt mix of the invention as a function of a number of cycles to failure N_{f}),
on FIGS. 2 to 5 a core cross-section after indirect tensile test with fatigue failure: FIG. 2 is a comparative example while FIGS. 3 and 4 represent asphalt mix core specimens according to the invention;
on FIG. 6 a diagram illustrating the influence of the aggregate particle size as a function of a number of cycles to failure.

For the remainder of the description, unless otherwise specified, the indication given in the present invention for a value range of “from X to Y”, is intended to include the values X and Y.

Also as used herein, the “size” of an aggregate contained in the granular mixture corresponds to its diameter if this aggregate has a spherical shape, like sand. If such aggregate is not spherical, its size corresponds to the length of its primary axis, that is to say to the longest straight line which can be drawn from one end of this aggregate to an opposite one. The geometrical characteristics of aggregates are in particular measured according to the NF EN 933-1 Standard.

According to the present invention, a granular class, noted d/D with d<D, is intended to mean a range of particle sizes in conjunction with a mesh lower size (d) and a mesh higher size (D), expressed in mm and thus includes grains which size varies from d to D; a granular class, noted 0/d′ with 0<d′, is intended to mean a range of particle sizes in conjunction with a mesh lower size (0) and a mesh higher size (d′), expressed in mm and thus includes grains which size varies from 0 to d′.

According to the present invention, the granular mixture typically is composed of natural, synthetic or recycled aggregates satisfying in particular the NF EN 13043 and NF P 18-545 Standards.

As used herein, a “natural aggregate” is intended to mean an aggregate having undergone no deformation other than a mechanical one (reduction by crushing). As used herein, a “synthetic aggregate” is intended to mean an aggregate resulting from an industrial process comprising thermal transformations or others.

As used herein, a “recycled aggregate” is intended to mean an aggregate derived from pavement demolition products or from new or used ballast of the SNCF (Railway company of France) or the RATP (Paris transport company), in other words the bed made of stones or small gravels onto which lie the rails of a railway. It also can be aggregates of crushed concrete, that is to say resulting from the reduction by crushing and screening of concretes derived from the deconstruction of concrete structures (pavement, buildings, civil engineering works). A pavement demolition product, also called “Reclaimed Asphalt Pavement” (RAP), is intended to mean an aggregate resulting from demolition products (such as asphalt mixes from old crushed and/or milled pavements). The other aggregates that may be used are road aggregates, meeting the following Standards: NF EN 13043 in Europe and ASTM C33 in the United States. Preferably, the granular mixture comprises recycled aggregates.

The applicant focused on the development of new formulations for a sub-base layer adapted to the road professional requirements, that is to say provided with a high durability, high mechanical resistances while offering a good quality-price ratio (raw materials are not so expensive and the binder amount is relatively less important).

As previously stated, the present invention relates to a SAB composition comprising at least a hydrocarbon binder and a granular mixture based on aggregates which may be chosen from: fines, sands, chips, small gravels, reclaimed asphalt pavements (RAP), ballasts or combinations thereof.

The SAB composition of the invention on one hand is especially characterized by a void content, in volume, as compared to the SAB composition total volume, as measured according to the NF EN 12697 Standard at 120 gyrations in a gyratory shear compactor (GSC), which is lower than or equal to 10%, preferably lower than or equal to 8% or typically lower than or equal to 6%. For example, the void content may reach from 2 to 9% and most preferably from 4 to 8%.

Because of the high particle size of the SAB composition, marked edge effects could be observed during the experimental trials in the periphery of the cores. These edge effects are detrimental to the test results as compared to the reality that can be observed in situ. The previously defined void percentage ranges at 120 gyrations take such an imponderable into account.

In fact the SAB composition of the invention thus is very compact (the compactness thereof ranges from 92 to 98%, in volume, as compared to the SAB composition total volume after compaction). For traditional RBA, this compactness ranges from 89 to 95%. The excellent compactness of the SAB composition of the invention thus ensures towards the ground support a better sealing compared to RBA and as a consequence reveals perfect for making sub-base layers.

The SAB composition of the invention is on the other hand characterized in that said granular mixture has the following particle size distribution by weight as compared to the granular mixture total weight:
45 to 90%, preferably 50 to 70% of the granular mixture have a size that is higher than or equal to 10 mm, with at least 25%, preferably at least 30% and most preferably at least 33%, and especially 35 to 50% having a size that is higher than or equal to 20 mm; and thus
10 to 55%, preferably 30 to 50% of the granular mixture has a size lower than 10 mm.

As used herein, an amount of at least 25% by weight of the granular mixture having a size that is higher than or equal to 20 mm includes the following percentages: 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60 and ff, and typically the following percentages: 25, 26, 27, 28, 29, 30, 31, 32, 33, 34, 35, 36, 37, 38, 39, 40, 41, 42, 43, 44, 45, 46, 47, 48, 49 and 50, and any range between two of these values.

Thus, the granular mixture of the invention comprises a first grainy granular fraction called d/D, wherein d is higher than or equal to 10 mm. Generally the maximum size D has a size that is lower than or equal to 50 mm, preferably lower than or equal to 40 mm, even lower than or equal to 31.5 mm.

As a comparison, in a traditional RBA or HMA formulation, the standard grading used is 0/10, 0/14 to 0/20 mm. For these RBA and HMA asphalt mixes the fraction 20/D does not exceed 10 to 15% maximum by weight, as compared to the RBA or HMA total weight. Yet, in the SAB composition of the invention, this percentage, also expressed by weight as compared to the SAB composition total weight, does reach more than 25%, especially more than 30% and may attain up to 50%.

As will be demonstrated in the experimental trials, using a high amount of strongly grained elements enables to improve the mechanical properties of the SAB composition by controlling and especially by delaying the reflective cracking which occurs during the lifetime of the sub-base pavement.

Unexpectedly, using a high amount of grained aggregates does not interfere with excellent compactness properties in the SAB composition (void content 0% according to the NF EN 12697 Standard).

The fractions that can be employed for this first granular fraction are for example the fractions with particle sizes 10/20 mm, 10/14 mm, 20/40, etc. or combinations thereof.

In particular aggregates of the first grainy granular fraction d/D may be, without limitation aggregates chosen from: small gravels, chips, sands, reclaimed asphalt pavements (RAP) or SNCF ballasts, or combinations thereof.

These aggregates, codified according to the NF P18 545 Standard especially integrate the intrinsic characteristics among codes B and C in paragraph 7 of the standard.

In particular, the granular mixture with a particle size that is higher than or equal to 10 mm, or even higher than 20 mm preferably has a cubic shape. It has in particular a low kurtosis value ranging from about 0 to 20%, preferably lower than or equal to 15% such as measured according to the NF EN 933-3/A1 Standard on the 16, 20, 25 and 31.5 mm-slotted grids.

As used herein, a kurtosis coefficient ranging from 0 to 20% includes the following values or any range therebetween: 20%, 19%, 18%, 17%, 16%, 15%, 14%, 13%, 12%, 11%, 10%, 9%, 8%, 7%, 6%, 5%, 4%, 3%, 2%, 1% and ff.

The applicant surprisingly discovered that introducing “flat” aggregates into the mixture would reinforce the weakness of the granular structure towards reflective cracking within the GAS composition mosaic and that, on the contrary, introducing aggregates with a low kurtosis coefficient would promote and increase the compactness of the GAS composition and of the resulting coating, as well as its fatigue resistance.

For example, SNCF ballasts 20/32 or 20/40 mm may be suitably used for making aggregates with particle sizes 20/D according to the present invention. They are divided into 3 classes called IB, II and III depending on their geometrical and physical characteristics.

As a rule, the natural ballast of railway tracks results from the crushing of natural rocks extracted from sound banks of hard stone quarries, except all unsound banks, and after having removed all gangue and crusts from the quarry, earth-type or organic wastes, sands and other foreign matters. It cannot contain elements, the nature, the size or the content of which would render the same unsuitable for the expected use and durability. The ballast particle size d/D with d 20 mm checked by washing on normalized test sieves, according to the NF EN 933-1/A1 and NF P18 545 Standards is defined as follows:

| | |
|---|---|
| % of passing with d (10 mm) | ≦15% |
| % of passing with D (40 mm) | ≧85% |
| % of passing with 1.4 * D | ≧95% |
| % of passing with 2 * D | 100% |
| % of fines (≦0.063 mm) | ≦3% |
| Fine cleanness | MBf ≦ 10 |

The value of its kurtosis coefficient, such as measured on 10 mm, 12.5 mm, 16 mm and 20 mm-slotted grids, according to the NF EN 933-3/A1 Standard, cannot be higher than: 15 for ballast 20/32, type IB; 20 for ballast 20/32, type II and III.

The SAB composition of the invention enables thus advantageously to recycle non traditional aggregates (subnormal), which moreover are less expensive than traditional aggregates.

According to a characteristic of the present invention, at least one part of the granular mixture, which size is higher than or equal to 10 mm, preferably higher than or equal to 20 mm (that is to say the first grainy granular fraction d/D) are recycled aggregates, such as SNCF ballasts or recycled crushed concrete.

Preferably, the granular mixture is further characterized in that it comprises less than 25% (limits included), preferably 6 to 15%, more preferably 8 to 15% by weight, as compared to the granular mixture total weight, of a second granular fraction, called sand fraction (Old′) composed of aggregates, which size is lower than or equal to 4 mm (0/4), preferably lower than or equal to 2 mm (0/2). As a rule, typical RBA and HMA rather comprise 30% to 45% by weight of 0/2 or 0/4 mm fraction.

This sandy fraction contributes to the workability of the product given its combinability with the hydrocarbon binder. Its optimized amount makes it possible to fill within the finished product a major part of the cracks between the grainiest elements, without bringing about their relative separation. According to the present invention, the sand content can be all the more reduced as the reclaimed asphalt pavement (RAP) content is high in the final mixture.

The aggregates in the sandy fraction may be, without limitation: sands, fillers, fine sands (very thin grains), dusts, reclaimed asphalt pavements or combinations thereof.

Fillers, also called fines, correspond to a mineral powder which particle size is generally lower than 63 μm, whereas sands generally correspond to any rock coming as small unbound grains which size may reach up to 4 mm.

According to a further aspect of the present invention, the granular mixture having a size lower than or equal to 10 mm comprises 0 to 50% (also 10 to 50%), preferably 0 to 40% by weight, as compared to the total weight of this fraction, of reclaimed asphalt pavements (RAP), the remainder being sand with an average diameter of 0/2 mm or 0/4 mm, small gravels/chips having a size of 0/10 mm, or combinations thereof.

As a rule, the granular mixture comprises 20 to 35% by weight, as compared to the granular mixture total weight, of reclaimed asphalt pavements (RAP). The SAB asphalt mix of the invention thus enables to re-use aggregates from old pavements, while imparting an attractive economical value and being more eco-aware.

In an alternative embodiment, the composition of the granular mixture is discontinuous, even twice discontinuous. This characteristic makes it possible to incorporate into the raw matrix containing chips having average particle size 20 mm, other smaller fractions, intended to optimize the granular arrangement without causing any relative separation of the larger elements during the compaction process and thus minimize the void percentage.

In a further alternative, the granular mixture optionally comprises by weight, as compared to the granular mixture total weight, 0 to 30%, preferably 0 to 20%, even 0 to 18% and most preferably 8 to 15% of a third granular fraction, called intermediate fraction (d′/D′), with a size ranging from 4 (not included) to 10 mm (4/10) (10 not included).

The intermediate fractions that can be used are for example fractions with particle sizes 6/10, 4/10, 2/10, or combinations thereof.

The aggregates of the intermediate fraction of the invention have preferably a true density, as measured according to the NF EN 1097-6 Standard, higher than 2000 kg/m³ and even higher than 2500 kg/m³. For example, the granular intermediate fraction d′/D′ can have a particle size chosen from 4/6.3; 6.3/10; 10/14; 14/20 or 10/20 mm, or combinations thereof. These granular classes are such as defined by the NF P18-545 Standard.

Advantageously such an intermediate fraction (d′/D′) especially enables the largest elements of the SAB composition mineral skeleton to better position during the compaction process (ball bearing effect) and thereafter to stabilize the final granular structure.

As an example, the asphalt mix of the invention may comprise the following granular mixture, by weight, as compared to the granular mixture total weight:
20 to 55%, preferably 25 to 50% and most preferably 35 to 40% of aggregates having a size that is higher than or equal to 20 mm, preferably of from 20 to 40 mm;
15 to 45%, preferably 20 to 35% and most preferably 25% of natural aggregates (chips, etc.) having a size ranging from 10 to 20 mm (non included);
20 to 40%, preferably 20 to 35% and most preferably 30% of reclaimed asphalt pavements having a size lower than 10 mm;
5 to 25%, preferably 8 to 15% and most preferably 10% of sands having a size ranging from 0 to 4 mm, and as a rule less than 15% of sands having a diameter ranging from 0 to 2 mm.

In the context of the present invention, the hydrocarbon binder is selected from: a bituminous binder, a plant- or an aqua-binder, or combinations thereof. Especially, the binder preferably represents by weight, as compared to the asphalt mix total weight, less than 4.5% (limit included), preferably 3 to 4% and most preferably 3 to 3.7%.

Thus, the SAB composition of the invention advantageously uses a hydrocarbon binder content that is much lower than the amounts traditionally used to prepare RBA or HMA. Indeed, for example, the hydrocarbon binder content by weight of the asphalt mix may be of about 3 to 3.7%, whereas for RBA it represents 4 to 5% and 5.2 to 6% for HMA. The sealed agglomerated base (SAB) composition of the invention is more economical than the products available on the market, while being provided with mechanical properties which are at least similar to those of RBA and to some HMA.

As used herein, a “hydrocarbon binder” is intended to mean a compound, which is able to harden and/or to bound together granular materials. Bitumen is a mixture of natural hydrocarbonated materials derived from the heavy fraction available from distillation of crude oil or coming from natural oil reservoirs in a solid or in a liquid form, which density generally ranges from 0.8 to 1.2. It may be prepared by means of any suitable method.

Accepted as bitumens in the spirit of the present invention are pure bitumens as defined in the NF EN 12591 Standard.

Bitumen may also be a modified bitumen as defined in the NF EN 14023 Standard. For example, bitumens may be modified by adding additives thereto, whatever their nature, such as additives intended to improve the adhesion characteristics, the resistance to extremely high and low temperatures or the mechanical resistance to high traffic or aggressive driving. To be also mentioned are bitumens, which have been improved by the incorporation of synthetic or natural elastomers or plastomers of the rubber powder type (polybutadiene, styrene-butadiene rubber or SBR), SBS, EVA or others. Various mixtures of bitumens of different types may also be suitably used.

As a rule, the hydrocarbon binder according to the present invention is not modified by the incorporation of additives (dopes, mineral or synthetic fibers).

The bitumen can in particular be chosen from bitumens having a penetration index at 25° C., determined according to the EN 1426 Standard, of 10/20, 15/25, 20/30, 40/60, 35/50, 50/70, 70/100 1/10^{tenth} of mm, or combinations thereof.

Also considered as hydrocarbon binders as used herein are binders of vegetable origin, such as Vegecol®, marketed by the Colas company and described in the patent application FR 2 853 647, synthetic binders of petroleum origin such as the Bituclair® binder series marketed by the Colas company or an “aqua-binder”. As used herein, an aqua-binder is intended to mean a product composed of water, natural elastomers and mineral nanoparticles.

The SAB composition of the invention can be implemented in a hot or cold condition, depending on the methods used by the person skilled in the art. For example, it may be prepared in a cold condition in a continuous or discontinuous coating plant.

The method may comprise the following steps consisting in:

(i) heating the hydrocarbon binder such as defined hereabove to a temperature higher than or equal to 110° C., preferably ranging from 120 to 170° C.,

(ii) pre-metering the various granular fractions 0/d, d′/D′ and d/D belonging to the formulation of the SAB composition of the invention, for example in dosing funnels;

(iii) optionally, drying and extracting dust from the various granular fractions, for example in dryers composed of a cylindrical tube rotating about its axis and fitted with a fuel oil or a gas burner that can heat the granular fractions at temperatures ranging from about 120 to 170° C., preferably from 150 to 170° C.;

(iv) mixing with the hot hydrocarbon binder the optionally dried granular fractions, generally in a mixer or in a drying cylinder.

The present invention further relates to a road coating comprising the material such as described hereafter.

On a cut surface of the sealed agglomerated base, aggregates of the first granular fraction (10/D) may represent more than 35% of the surface, preferably more than 40% of the surface and especially from 40 to 60% of the cut surface.

In particular the SAB composition is a sub-base mono-layer of said coating and has a thickness ranging from 8 to 20 cm forming both the base layer and the road base course of said coating.

As a rule, for traditional bituminous asphalt mixes, the application rule between the nominal thickness (e) of the base layer or of the road base course and the maximum particle size of the granular mixture D is as follows: e mini=4*D.

According to this rule:

4*10 mm=4 cm thickness in any point for asphalt mixes 0/10 mm,

4*14 mm=6 cm thickness in any point for asphalt mixes 0/14 mm,

4*20 mm=8 cm thickness in any point for asphalt mixes 0/20 mm.

A priori, for the SAB composition of the invention, there should be: 4*31.5 mm=12.6 cm thickness in any point for formulations 0/31.5 mm and 16 cm thickness in any point for formulations 0/40 mm, which would make the present invention less suitable for the most common uses (layers of unitary thickness ranging from 8 to 12 cm for each base layer and each road base course or for a sub-base mono-layer of the same thickness range under a lower traffic level).

Consequently, the applicant discovered that the SAB according to the present invention could be deposited not only in a single application with a common thickness ranging from 8 to 13 cm, including for formulations 0/40 mm, but in addition, in a single layer which could reach up to 16 to 20 cm, thus enabling to spare the tack coat usually required between two successive applications. Indeed, for RBA or HMA 0/14 mm, the maximum application thickness with a single-layer configuration does not exceed 13 cm. It reaches 15 cm for RBA or HMA 0/20 mm. In this case, the required compactness of the asphalt mix is harder to achieve.

With a SAB composition of the invention, it is different since compactness is all the more important and homogeneous as the thickness of the single layer is high.

The SAB composition of the invention shakes up the established rules as regards implementation, by allowing an easy application (one layer instead of two) for a mechanical efficiency level at least similar to that of RBA and some HMA.

As a rule, the SAB composition will be coated with a binder layer, itself coated with a wearing course, forming the surfacing layer of the road coating.

The road coating will be typically obtained through:
spreading of the SAB composition obtained at the end of step (iv) hereabove;
then compaction thereof (mechanical, etc.) and
last its cooling.

The previous steps are well known from the person skilled in the art and will not be further detailed hereafter.

In particular the road coating has a fatigue resistance for 1 million cycles, as measured according to the NF EN 12 697-24 (EPS6) Standard, which is higher than or equal to 85 μdef, preferably which ranges from 85 to 140 μdef, especially from 100 to 130 μdef and more particularly from 100 to 115 μdef.

It has in particular a complex rigidity modulus, as measured according to the NF EN 12697 Standard-26, which is higher than or equal to 11000 MPa, preferably higher than or equal to 12000 MPa and ranging especially from 11000 to 16 000 MPa and typically from 11 000 to 14 000 MPa.

Thus the SAB composition of the invention offers the following benefits:
it allows the re-use of subnormal aggregates, such as SNCF ballasts or of crushed concrete small gravels, using a high amount of grained aggregates with a size higher than 10 mm or even 20 mm, having a high hardness thus providing to the asphalt mix a high mechanical resistance; moreover, the distribution of the larger aggregates within the granular mixture significantly influences the fatigue test result, contrary to what the current French technique believes as regards asphalt mixes, for which technique the binder represents by far the leading vector of the final result; last, the development of cracks follow the contours of these larger aggregates, most of the time without coming through the same—blocking the fatigue crack against the same leads to the development of a second crack also forced to avoidance, thus enabling a retardation of the cracking process and providing as a consequence to the asphalt mix of the invention a high fatigue resistance. This significant phenomenon counterbalances the smallness of the binder content given the similar performances obtained with other classical mixtures comprising amounts of bituminous binder that are substantially higher.
it has a low hydrocarbon binder content, such as a bituminous binder, as compared to RBA and HMA, which makes it more economical;
it does not require the use of hard grade bitumens, such as 10/20. 15/25 even 20/30;
while having outstanding mechanical properties (similar to those obtained with a RBA4 or structurally comparable or even identical to those obtained with a normalized HMA2: a complex modulus or modulus in diametral compression, which is higher than or equal to 11 000 MPa, preferably higher than or equal to 12 000 MPa; a fatigue resistance for 1 million cycles with EPS6≧100 μdef, preferably near to or higher than 110 μdef, a compactness in situ ≧92%, preferably ≧94% and most preferably ≧96% and a resistance to permanent deformations (rutting): ≧7.5% with 30000 cycles);
it requires the application of a single layer of the SAB composition of the invention to form a monolithic sub-base layer instead of two individualized layers artificially bound together (base layer and road base course), as is the case with RBA and HMA;
it offers a compromise between workability (evolution of the void percentage), compactness, adhesion, roughness, and above all resistance to rutting.

The following non-limiting examples illustrate the present invention. In the following examples, unless a different unit of measurement is stated, the values are expressed by weight.

### EXAMPLES

### Example 1

### Example of a Laboratory Formulation of a SAB Composition of the Invention

A SAB composition of the invention, which formulation is illustrated in Table 1 was prepared in hot condition in a heat-regulated mixer. The bitumen was heated to a temperature of 150° C., the aggregates were previously pre-metered in vessels and heated to 150° C. prior to being introduced with the heated bitumen into a mixer for 5 minutes. The asphalt mix was then weighted in a suitably sized cylindrical mold, prior to being compacted by means of a gyratory shear compactor.

TABLE 1

| Compounds | Percentage (%) by weight |
|---|---|
| Recycled SNCF ballast 20-40 mm | 34 |
| Chips of massive crushed rock | 24 |
| 10/14 mm | |
| Sand of massive crushed rock | 8.4 |
| 0/4 mm | |
| R.A.P | 30 |
| Bitumen grade 50/70 | 3.6 |

The compaction mode of the cylinder in Example 1 was selected by a gyratory shear compactor, with a mold of 160 mm diameter, and a corresponding height of 150 mm, representing a void content of 0: once placed, bulked and at the test temperature (130° C. to 160° C. approx.) in the cylindrical mold.

It has been applied on the top of the mold a vertical pressure of 0.6 MPa; in the same time, the mold was inclined at a low angle of about 1° (external) or 0.82° (internal) and submitted to a circular movement. These various actions act as a compaction with a kneading effect.

### Example 2

The compaction mode of the SAB composition plates of Example 1 in the mold was selected by means of an internal test method using a compaction vessel fitted with pneumatic elements.

SAB composition plates were prepared with the following sizes: width 180 mm, length 600 mm and height 150 mm. Compaction was stop as soon as the expected specific gravity value was obtained.

A) Behavior Evaluation of the Asphalt Mix

Duriez Test or Water Sensitivity: Void Percentage/Compactness (EN 12697-12)

Principle of the Duriez test: the mixture is compacted in a cylindrical mold by a static pressure with double effect. Part of the specimens were stored without dipping at temperature (18° C.) and their hygrometry controlled, the other part was kept dipped. Each group of specimens was crushed under simple compression.

Interpretation of the Duriez test: the ratio of resistance after dipping to dry resistance gives the water resistance of the mixture. The dry resistance is an approach to determine the mechanical characteristics, and the compactness an indicator to complement the compaction test in the Gyratory Shear Compactor (GSC).

Compaction Test in GSC (EN 12697-31)

Principle of the GSC test: the mixture is contained in a cylindrical mold delimited by dots and stored at a constant temperature for the all duration of the test; aim of the process being to determine the void percentage of a specimen after a given number of gyrations.

Interpretation of the GSC test: at the end of the compaction and once the proof bodies have been cooled, a vertical central sawing is effected, so as to evaluate de visu, the harmonization of the larger elements and to observe the nature of the edge effects and the homogeneity of the compaction.

B) Coring of the Asphalt Mix Obtained in Example 2 of the Present Invention

To determine the modulus and fatigue behavior of the SAB composition of Example 1 with large particle sizes incorporating the SNCF recycled ballast and RAP, a coring was carried out to obtain cores with a 50 mm thickness and a 100 mm diameter.

The coring of the specimens was effected in the central part and in the side part of the plates, so as to have a good distribution of the materials for each proof body, to minimize the effect of density gradient, and also to avoid their weakening due to the edge effects.

12 cores were thus collected.

The results are summarized in Table 3 hereafter. The void percentage (geometrical but also hydrostatic) makes it possible to do a first sequencing of the cores. As can be observed, all the cored specimens, once sawed, have void values relatively close, of about 2.5 to 4.9%; in fact no one was excluded by this criterion.

As a consequence, the SAB composition of the invention has a void percentage ranging from 2.5 to 5% (similar level to that of HMA2) and has as well as the material of the present invention an excellent compactness considering its particle size. This demonstrates that it is very compact and capable to ensure a good sealing level towards the ground support onto which it is implemented.

Modulus of Rigidity (NF EN 12697_{—}26 Appendix C)

The modulus of rigidity is calculated according to the NF EN 12697-26 Standard appendix C.

TABLE 2

| | Modulus of | | | |
|---|---|---|---|---|
| | elasticity E | | Void % | Compactness |
| Specimens | (MPa) | Load | s.s.s. | (%) |
| 5 | 14710 | 1650 | 3.5 | 96.50 |
| 3 | 14046 | 700 | 2.5 | 97.50 |
| 1 | 13997 | 1500 | 2.8 | 97.20 |
| 11 | 13456 | 800 | 4.9 | 95.10 |
| 4 | 13021 | 1450 | 2.4 | 97.60 |
| 9 | 12998 | 850 | 3.4 | 96.60 |
| 8 | 12993 | 1350 | 4.9 | 95.10 |
| 6 | 12499 | 1000 | 4.3 | 95.70 |
| 2 | 12429 | 1200 | 4.3 | 95.70 |
| 10 | 12358 | 950 | 3.3 | 96.70 |
| 12 | 12232 | 1150 | 4.8 | 95.20 |
| 7 | 12036 | 1050 | 4.2 | 95.80 |

This test shows that the SAB composition of the invention has a complex modulus or a modulus in diametral compression, which is higher than or equal to 12 036 MPa, i.e. positioned in the upper part of the RBA4 class and at the limit of that of a HMA2. In addition the gaps between the values are rather low and within the repeatability limit of the module assays.

Diametral Compression Fatigue Test: ITFT (NF EN 12 697-24 Appendix E)

The indirect tensile test with fatigue failure conducted according to appendix E of the EN 12697-24 Standard, at 10° C., is used to classify the bituminous mixtures in terms of fatigue resistance, by estimating the lifetime of the mixture under constant stress, until a failure occurs in the proof bodies.

The load during the ITFT test for each specimen is selected arbitrarily from the results of the rigidity modulus, classified in Table 2. The results of the first three assays enable to readjust the loads recorded at the beginning, so as to improve the repeatability of the fatigue tests. A first distribution of the specimens was made by classifying them in descending order according to the modules (Table 2). The applied stresses were distributed alternately (high, low, high, low . . . ), so as to have a centered distribution.

The results of the indirect tensile test with fatigue failure are summarized in Table 3.

TABLE 3

| | | | | Initial | | | Number |
|---|---|---|---|---|---|---|---|
| | Diam- | | | total de- | Loading | resilient | of |
| Spec- | eter | Height | Load | formation | cycles | def. | energ. |
| imens | (mm) | (mm) | (kPa) | (με₀) | Nf | (με0) | cycles |
| 1 | 100 | 52.2 | 1650 | 235 | 6000 | 178 | 5000 |
| 8 | 100 | 50.3 | 1350 | 209 | 18000 | 158 | 12000 |
| 5 | 100 | 50.3 | 1650 | 198 | 9000 | 153 | 8000 |
| 6 | 100 | 50.4 | 1000 | 126 | 86000 | 107 | 60500 |
| 2 | 100 | 49.7 | 1200 | 163 | 15500 | 125 | 11500 |
| 9 | 100 | 50.0 | 800 | 94 | 823000 | 82 | 624500 |
| 12 | 100 | 50.7 | 1650 | 251 | 5500 | 185 | 4500 |
| 10 | 100 | 51.5 | 900 | 134 | 306500 | 111 | 245500 |
| 7 | 100 | 50.9 | 900 | 129 | 97000 | 103 | 63500 |
| 3 | 100 | 50.1 | 850 | 96 | 414500 | 80 | 333000 |
| 4 | 100 | 50.0 | 1450 | 189 | 26500 | 147 | 21500 |
| 11 | 100 | 50.5 | 1050 | 114 | 88500 | 101 | 64000 |

The deformation values and the number of loading cycles, summarized in Table 3, enable to represent the initial total deformation as a function of the failure cycle, illustrated on Figurel.

The value of the failure cycle number N_{f} follows the following law: Nf=10k*(1/ε₀)ₙ with:

Nf: failure cycle number,

ε₀: initial total deformation (μdef),

K and n: constants calculated from the slope and the straight line defining the curve.

Referring now to FIG. 1, it can be observed that the deformations obtained for the twelve specimens form three areas. A high deformation area (very short cycles), a low deformation area (very long cycles), and a transition area (intermediate cycles).

Thus, the SAB composition of the invention, with a high amount of ballast 0/40 has an elasto-plastic behavior, in which:
with high stresses, the initial total deformation is strong; the specimen lies in a plastic range.
With low stresses, the deformation is very small; the specimen lies in an elastic range.

The distribution of the test unitary results (each point of the diagram) thus reveals a behavior that is typical for the SAB mixture: three properly distinct clouds of points are materialized and correspond to variations in the behavior of the material. This observation is surprising because for the whole usual coated materials, the distribution of the points along the fatigue straight line is continuous. That is not the case with the SAB.

In other respects, a confidence interval was determined so as to provide a test acceptability domain.

To that end, a classification of the specimens as a function of the three deformation areas (plastic, elastic, transition) was effected, and then the averages of the initial deformations were calculated as indicated in the following Tables 4 and 5:

TABLE 4

| | | | Loading | Initial total | Number of | Initial total | Number of | Initial |
|---|---|---|---|---|---|---|---|---|
| | Diameter | Height | stress | deformation | loading cycles | deformation | corresponding | total def |
| Specimens | (mm) | (mm) | (kPa) | (με₀) | (Nf) | average | failure cycles | adjust. |
| 12 | 100 | 50.7 | 1650 | 251 | 5500 | 211 | 10177 | 240 |
| 1 | 100 | 52.2 | 1650 | 235 | 6000 | | | 236 |
| 8 | 100 | 50.3 | 1350 | 209 | 18000 | | | 187 |
| 5 | 100 | 50.3 | 1650 | 198 | 9000 | | | 217 |
| 2 | 100 | 49.7 | 1200 | 163 | 15500 | | | 193 |
| 11 | 100 | 50.5 | 1050 | 114 | 88500 | 123 | 133972 | 134 |
| 7 | 100 | 50.9 | 900 | 129 | 97000 | | | 132 |
| 6 | 100 | 50.4 | 1000 | 126 | 86000 | | | 135 |
| 3 | 100 | 50.1 | 850 | 96 | 414500 | 108 | 249328 | 97 |
| 9 | 100 | 50.0 | 800 | 94 | 823000 | | | 84 |
| 10 | 100 | 51.5 | 900 | 134 | 306500 | | | 103 |

TABLE 5

| | | | Loading | Initial | Number of | Resilient def. | Resilient | Resilient |
|---|---|---|---|---|---|---|---|---|
| | Diameter | Height | stress | total def. | loading cycles | to 100 cycles | def. | def. |
| Specimens | (mm) | (mm) | (kPa) | (με₀) | (Nf) | (με0) | average | adjusted |
| 12 | 100 | 50.7 | 1650 | 251 | 5500 | 184.6 | 160 | 179 |
| 1 | 100 | 52.2 | 1650 | 235 | 6000 | 177.9 | | 177 |
| 8 | 100 | 50.3 | 1350 | 209 | 18000 | 158.3 | | 145 |
| 5 | 100 | 50.3 | 1650 | 198 | 9000 | 1520.6 | | 164 |
| 2 | 100 | 49.7 | 1200 | 163 | 15500 | 124.5 | | 149 |
| 11 | 100 | 50.5 | 1050 | 114 | 88500 | 101 | 104 | 110 |
| 7 | 100 | 50.9 | 900 | 129 | 97000 | 103 | | 108 |
| 6 | 100 | 50.4 | 1000 | 126 | 86000 | 106.5 | | 110 |
| 3 | 100 | 50.1 | 850 | 96 | 414500 | 79.7 | 91 | 83 |
| 9 | 100 | 50.0 | 800 | 94 | 823000 | 82 | | 74 |
| 10 | 100 | 51.5 | 900 | 134 | 306500 | 111.4 | | 88 |

By means of the hereabove equation, the corrected deformation values have been calculated, and a new average as well as the corresponding failure cycle were determined for each area. Last, the standard deviation between each average was calculated.

The number of cycles to failure follows the law Nf=10k*(1/ε₀)ⁿ. n and k were then determined by searching the slope and the ordinate defining the curve.

Total ITFT

| με | Nf |
|---|---|
| 134 | 91 453 |
| 113 | 200 000 |

K = 9.15E+14
R² = 0.8
n = −4.70

resilient ITFT

| με | Nf |
|---|---|
| 130 | 345 288 |
| 108 | 100 000 |

n = −5.55
k = 1.90E+16
R² = 0.87

Thus, the initial total deformation accepted for 200 000 cycles of the SAB composition of Example 1 according to the present invention is 113±9 μdef.

Referring now to FIGS. 2 to 5, the behavior of the SAB composition of the invention will be described.

FIG. 2 illustrates the usual behavior of an asphalt mix with particle sizes 0/14 mm during the diametral compression fatigue test. As can be seen, FIG. 2 is characterized by a relatively rectilinear development of the fatigue crack, the latter going substantially through the sealant (sand+filler+bitumen) and hardly passing around the aggregates, considering their sizes. Thus, the sealant is prominent in the transmission of the fatigue crack. The aggregates are too “small” to efficiently counterbalance the transmission of tensile stresses into the specimen.

FIG. 3 illustrates the behavior of core 4 of the present invention during the diametral compression fatigue test. Unlike the previous mixture, the density of small gravels and ballast chips of the SAB composition of Example 1 is such that the fatigue crack hardly develops. The latter is thus forced, either to avoid the largest aggregates, which are harder, or to try to pass around/go through them. In this event, the fatigue resistance of the SAB composition partially depends on the distribution and of the hardness of its large aggregates.

FIG. 4 also illustrates the behavior of core 7 of the present invention during the diametral compression fatigue test. In the present case, a first crack has developed from the bottom of the specimen, then has been hindered by a large aggregate (finally expelled at the end of the test). A second crack appeared within the specimen, but could not develop to the top, hindered by a large element.

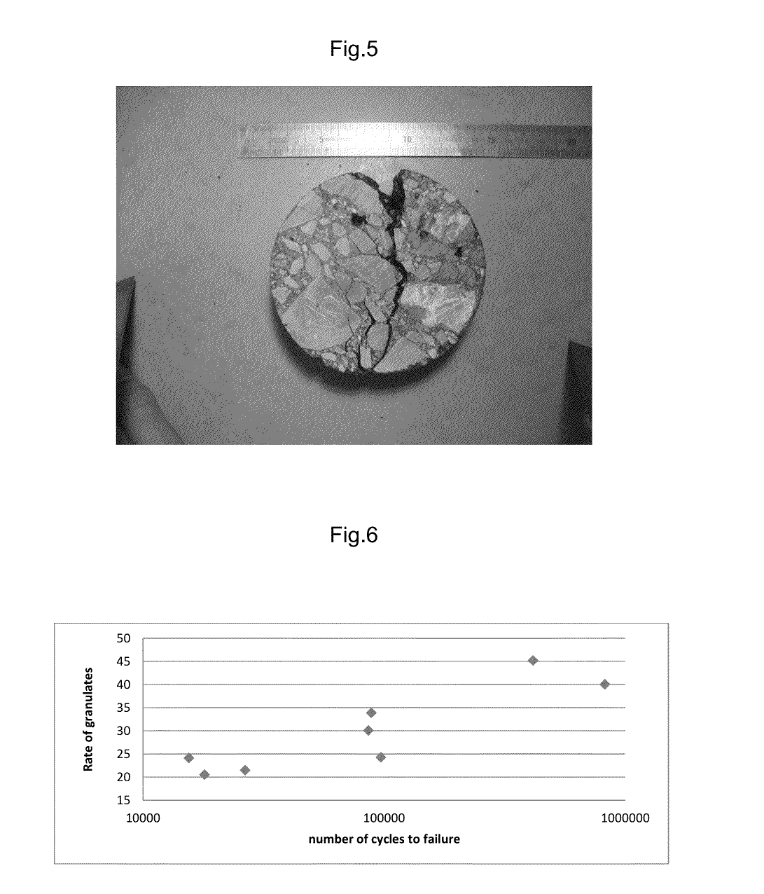

FIG. 5 illustrates the behavior of core 2 of the present invention during the diametral compression fatigue test. In that case a triple crack can be observed. The main crack on the right tripped over a first aggregate (with a medium size of about 10 mm) but could not develop further. A start of crack was recreated from the bottom of the specimen, but get lost in a larger aggregate, that was more resistant than the previous one. The first aggregate, of lesser intrinsic quality, finally gave way. The third crack in the center is a crack caused by the variable stress field between crack 1 and crack 2.

As a consequence, FIGS. 3 to 5 show that aggregates with a larger diameter (larger size), especially higher than 20 mm, prevent the one or more cracks to spread quickly, which enables a better control or a greater knowledge of the cracking process. Thus, the lifetime of the SAB composition of the invention is improved as compared to a classical asphalt mix having a bitumen metering similar to that the present invention (FIG. 2).

Granulomorphology

How ballast influences the behavior of the proof bodies during the indirect tensile test with fatigue failure was also studied.

Using the software ImageJ, it could be determined, for each failure surface of the above-mentioned specimens, the relative proportion of mineral elements with a particle size higher than or equal to 10 mm and of thinner elements, including the sealant (sand+filler+bitumen), which could be found in the fracture plane. Then the percentage of the ballast as a function of the failure cycle was determined.

It could thus be observed that cores have various rates of larger aggregates (3 cores comprise 20 to 25% by weight of larger aggregates >20 m, 3 cores comprise 25 to 35% by weight of larger aggregates >20 m and 2 cores comprise 40 to 45% by weight of larger aggregates >20 m).

Referring now to FIG. 6, it can be observed that the higher the number of larger aggregates, the higher the number of cycles to failure. The three previously defined deformation areas are also present. In each zone, the percentage of aggregates having influenced the failure (FIG. 6) for each specimen remains relatively close:
For 20000 cycles between 20 and 25%.
For 100000 cycles between 25 and 35%.
For 700000 cycles between 40 and 45%.

It can be observed that the higher the percentage of larger elements at the level of the failure surface, the better this one can withstand a high number of loading cycles.

The failure cycle strongly depends on the binder rate deposited onto the broken surface as well as on the larger element distribution. Under a low stress, and with a low binder rate, the deformation will thus be low, moreover the failure cycle will be high. Conversely under high stresses.

The initial total deformation for each specimen depends indeed on the granular distribution and on the amount of the binder deposited onto the ballast. The higher the binder amount, the higher the deformation, the lower the fatigue endurance.

Although the present invention has been described as referred to a particular embodiment, it should be clearly understood that it is in no way limited thereto, and that it comprises all the technical equivalents of the here described means as well as their combinations, provided they belong to the scope of the invention.

1. A sealed agglomerated base (SAB) composition comprising at least a hydrocarbon binder and a granular mixture, said granular mixture having the following particle size distribution, by weight, as compared to the granular mixture total weight: from 45 to 90% of the granular mixture have a size that is higher than or equal to 10 mm, with at least 25% having a size that is higher than or equal to 20 mm, characterized in that the void content in volume as compared to the SAB composition total volume, as measured according to the NF EN 12697 Standard, at 120 gyrations in a gyratory shear compactor (GSC), is lower than or equal to 10%.

2. A SAB composition according to claim 1, wherein less than 25% (limits included), preferably from 6 to 15% by weight of the granular mixture have a size lower than or equal to 4 mm.

3. A SAB composition according to claim 1, wherein the granular mixture having a size that is higher than or equal to 10 mm has a low kurtosis coefficient of about 0 to 20%, preferably lower than 15%, such as measured according to the NF EN 933-3/A1 Standard on 16, 20, 25 and 31.5 mm-slotted grids.

4. A SAB composition according to claim 1, wherein the hydrocarbon binder is selected from a bituminous binder, a plant-based binder, an aqua-binder or combinations thereof, and represents by weight as compared to the sub-base layer composition total weight, less than 4.5%, preferably 3 to 4% and most preferably 3 to 3.7%.

5. A SAB composition according to claim 1, wherein the hydrocarbon binder has a penetration index at 25° C., determined according to the EN 1426 Standard, of 10/20, 15/25, 20/30, 40/60, 35/50, 50/70, 70/100 1/10^{tenth} mm or combinations thereof.

6. A SAB composition according to claim 1, wherein the granular mixture comprises recycled aggregates.

7. A SAB composition according to claim 6, wherein at least part of the granular mixture with a size higher than or equal to 10 mm represents recycled aggregates.

8. A SAB composition according to claim 6, wherein the granular mixture with a size lower than or equal to 10 mm comprises 0 to 50% by weight as compared to the total weight of this fraction, of reclaimed asphalt pavements.

9. A SAB composition according to claim 6, wherein 10 to 50% by weight of the granular mixture, as compared to the granular mixture total weight, are reclaimed asphalt pavements (RAP).

10. A road coating comprising the SAB composition according to claim 1.

11. A road coating according to claim 10, wherein said SAB composition is a sub-base mono-layer having a thickness of from 8 to 20 cm forming both the road base layer and the road base course of said coating.

12. A road coating according to claim 10, wherein said SAB composition is coated with a binder layer, itself coated with a wearing course, forming the surfacing layer of the road coating.

13. A road coating according to claim 10, wherein in a cut surface of said SAB composition, aggregates having a particle size higher than or equal to 10 mm represent more than 35% of the surface, preferably more than 40% of the surface and especially 40 to 60% of the cut surface.

14. A road coating according to claim 10, characterized in that it has a fatigue resistance for 1 million cycles, as measured according to the NF EN 12 697-24 (EPS6) Standard, which is higher than or equal to 85 μdef, which preferably ranges from 85 to 140 μdef, especially from 100 to 130 μdef and more particularly from 100 to 115 μdef.

15. A road coating according to claim 10, characterized in that it has a complex modulus of rigidity as measured according to the NF EN 12697-26 Standard, higher than or equal to 11000 MPa, preferably higher than or equal to 12000 MPa and especially ranging from 11000 to 16 000 MPa.

16. A SAB composition according to claim 2, wherein the granular mixture having a size that is higher than or equal to 10 mm has a low kurtosis coefficient of about 0 to 20%, preferably lower than 15%, such as measured according to the NF EN 933-3/A1 Standard on 16, 20, 25 and 31.5 mm-slotted grids.

17. A SAB composition according to claim 7, wherein the granular mixture with a size lower than or equal to 10 mm comprises 0 to 50% by weight as compared to the total weight of this fraction, of reclaimed asphalt pavements.

18. A SAB composition according to claim 7 wherein 10 to 50% by weight of the granular mixture, as compared to the granular mixture total weight, are reclaimed asphalt pavements (RAP).

19. A SAB composition according to claim 8, wherein 10 to 50% by weight of the granular mixture, as compared to the granular mixture total weight, are reclaimed asphalt pavements (RAP).

20. A road coating according to claim 11, wherein said SAB composition is coated with a binder layer, itself coated with a wearing course, forming the surfacing layer of the road coating.
